(19) United States
(12) Patent Application Publication
(10) Pub. No.: US 2008/0041116 A1
(43) Pub. Date: Feb. 21, 2008

(54) Rotating body control device and washing machine including the same

(75) Inventors: Naoki Kanazawa, Minoosi (JP); Seilchiro Suzuki, Minoosi (JP); Shoichi Matsui, Minoosi (JP); Sadayuki Sato, Minoosi (JP)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/882,096

(22) Filed: Jul. 30, 2007

(30) Foreign Application Priority Data
Aug. 21, 2006 (JP) 2006-224116

(51) Int. Cl. D06F 29/02; G01M 1/02

(52) U.S. Cl. 68/23.2; 73/459

(57) ABSTRACT

Disclosed herein are a rotating body control device and a washing machine. The rotating body control device includes: a balancing unit including an annular race which is integrally formed with the rotating body and is concentric with the rotation shaft of the rotating body and a plurality of rolling bodies which are movably seated in the race; a detecting unit detecting a bit signal, which is generated according to a variation in relative position between the rolling bodies seated in the race and the eccentric amount of the rotating body which occurs during the rotation of the rotating body; an analyzing unit which analyzes a variation in amplitude of the bit signal detected by the detecting unit; and a control unit which controls the rotation of the rotating body according to the analyzed result of the analyzing unit.

### CROSS-REFERENCE TO RELATED APPLICATIONS

This application claims the benefit of Japanese Patent Application No. 2006-224116, filed on Aug. 21, 2006 in the Japanese Patent Office, the disclosure of which is incorporated herein by reference.

### BACKGROUND

1. Field

The present invention relates to a rotating body control device controlling the operation of a rotating body, in which an eccentric state that is unbalanced may occur during rotation thereof, and a washing machine including the same.

2. Description of the Related Art

A rotating body, in which an imbalance occurs, may be a spin basket of a washing machine. In the dehydrating process of a washing machine, laundry put in the spin basket is unevenly distributed along the inner circumference of the spin basket such that the imbalance occurs. In this state, when the spin basket rotates at a high speed, a force is biased along the rotation shaft of the spin basket and generates large vibrations.

In order to prevent the vibrations due to such an imbalance, a washing machine including a race which is provided to be concentric with the spin basket and a balancing unit having a plurality of rolling bodies seated in the race together with oil is disclosed in Japanese Unexamined Patent Application Publication No. 10-43472.

In the washing machine disclosed in the above Publication, when the spin basket rotates at a high speed, rolling bodies automatically move in the race to prevent the force from being biased along the rotation shaft.

However, in a washing machine including a balancing unit, when the unbalanced weight is larger than the total weight of the rolling bodies, the imbalance cannot be sufficiently removed even if the rolling bodies are located opposite the circumferential side of the imbalance (opposite phase). Thus, vibrations naturally occur. The unbalanced weight indicates an eccentric amount of the rotating body which occurs during rotation.

In the balancing unit, when the number of rotations of the spin basket is larger than the inherent number of vibrations of the spin basket, it is known that the rolling bodies are stably positioned to cope with the imbalance.

Meanwhile, when the number of rotations of the spin basket is smaller than the inherent number of vibrations of the spin basket, a difference between the moving speed of the rolling bodies and the moving speed of the imbalance (that is, the rotation speed of the spin basket) occurs such that the relative position between the imbalance and the rolling bodies periodically varies.

When the rolling bodies and the imbalance are positioned at the same location (same phase) in the circumferential direction, a larger force is applied to the rotation shaft to generate larger vibrations. If the rolling bodies and the balance are positioned at the same phase at a time point when the number of rotations of the spin basket is equal to the inherent number of vibrations of the spin basket, such resonance significantly increases and thus abnormal vibrations occur.

### SUMMARY

Therefore, it is an aspect of the present invention to provide a rotating body control device including a rotating body having a balancing unit and a washing machine including the same, which are capable of reliably suppressing vibrations using the balancing unit and reliably suppressing the generation of abnormal vibrations due to a variation in relative position between imbalance in the rotating body and rolling bodies of the balancing unit.

Additional aspects and/or advantages of the invention will be set forth in part in the description which follows and, in part, will be apparent from the description, or may be learned by practice of the invention.

In accordance with the invention, the above and/or other aspects can be achieved by the provision of a rotating body control device controlling rotation of a rotating body including a rotation shaft, including: a balancing unit including an annular race which is integrally formed with the rotating body and is concentric with the rotation shaft of the rotation body and a plurality of rolling bodies which are movably seated in the race; a detecting unit detecting a bit signal, which is generated according to a variation in relative position between the rolling bodies seated in the race and an eccentric amount of the rotating body during the rotation of the rotating body; an analyzing unit which analyzes a variation in amplitude of the bit signal detected by the detecting unit; and a control unit which controls the rotation of the rotating body according to the analyzed variation in amplitude.

In the rotating body control device having the above-described configuration, since the bit signal, which is generated according to the variation in relative position between the rolling bodies seated in the race and the eccentric amount of the rotating body which occurs during the rotating of the rotating body, is detected and the variation in amplitude of the bit signal is analyzed, it is possible to calculate the imbalance weight or the relative position between the imbalance of the rotating body and the rolling bodies of the balancing unit in the circumferential direction. Since the operation of the rotating body is controlled by the calculated results, it is possible to suppress natural vibrations or abnormal vibrations of the rotating body.

The bit signal, which is generated according to the variation in relative position between the rolling bodies seated in the race and the eccentric amount of the rotating body which occurs during the rotation of the rotating body, may be a motor rotation speed, motor current, and motor acceleration when the motor rotates the rotating body.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a sectional view showing the configuration of a washing machine according to an embodiment of the present invention;

FIG. 2 is a schematic view of a balancing device included in the washing machine shown in FIG. 1;

FIG. 3 is a block diagram of the washing machine shown in FIG. 1;

FIG. 4 is a view showing a bit signal of the washing machine shown in FIG. 1;

FIG. 5 is a view showing a relationship between an unbalanced weight and the amplitude of the bit signal shown in FIG. 4;

FIG. 6 is a view showing a pattern in which the number of rotations of a motor which increases in a dehydrating process; and

FIG. 7 is a flowchart illustrating the dehydrating process of the washing machine shown in FIG. 1.

### DETAILED DESCRIPTION OF THE EMBODIMENT

Reference will now be made in detail to the embodiment of the present invention, an example of which is illustrated in the accompanying drawings, wherein like reference numerals refer to the like elements throughout. The embodiment is described below to explain the present invention by referring to the figures.

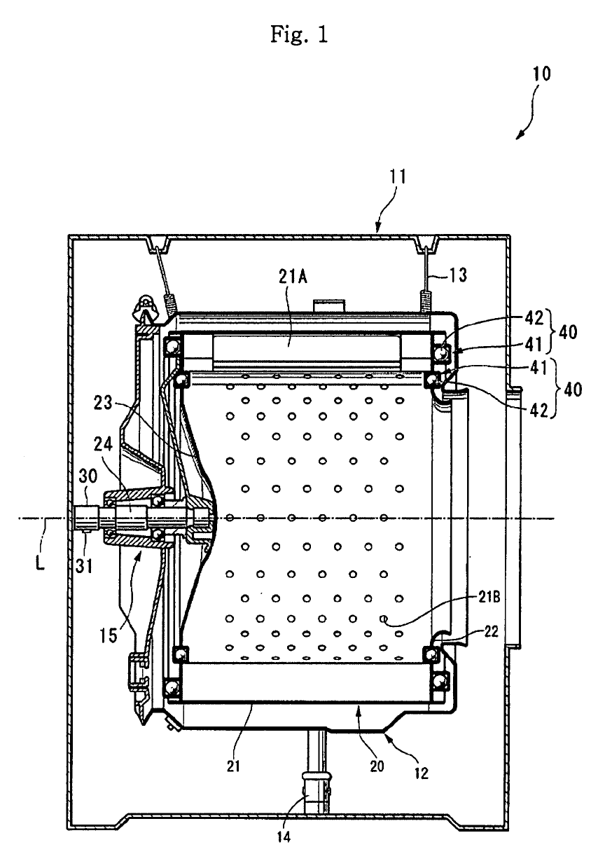

A washing machine 10 is a drum-shaped washing machine which can perform a washing and dehydrating process. As shown in FIG. 1, the washing machine 10 includes a casing 11, a tub 12 suspended in the casing 10, a spin basket 20 (rotating body) rotatably installed in the tub 12, a motor 30 which rotates the spin basket 20 about a rotation shaft L in a rotational direction, and a pair of balancing devices (balancing unit) 40 removing imbalance which occurs in the spin basket 20.

The tub 12 has a bottom and is cylindrically shaped. The central shaft of the tub 12 is disposed parallel to a horizontal plane and an opening is formed in the front side of the tub 12 (the right side of FIG. 1). The tub 12 is supported by a plurality of springs 13, or a damper, 14 within the casing 11. A bearing 15 supporting a main shaft 24 of the spin basket 20 is provided on the bottom of the tub 12.

The spin basket 20 provided in the tub 12 has a cylindrical side panel 21 and a front panel 22 and a back panel 23 which are respectively joined to the front and back surface of the side panel 21. An opening is formed in the front panel 22 so that laundry W can be put into or taken out of the spin basket 20 therethrough.

The main shaft 24 rotating the spin basket 20 about the rotation shaft L in the rotational direction is provided at the back side (the left side of FIG. 1) of the back panel 23. The main shaft 24 is supported by the bearing 15 of the tub 12. The rotation shaft L of the spin basket 20 and the central shaft of the tub 12 are equal to each other.

A plurality of lifters 21A protruded toward the inner circumferential side is provided on the side panel 21 in the circumferential direction at the same interval. The lifters 21A lift the laundry W therein according to the rotation of the spin basket 20.

A plurality of holes 21B communicating the inside of the spin basket 20 with the tub 12 is formed in the side panel 21. Water, which flows into the tub 12, is fed into the spin basket 20 through the holes 21B during the washing process and water, which flows out of the laundry W, flows into the tub 12 when the dehydrating process.

The motor 30 is, for example, a DC motor rotating the main shaft 24 about the rotation shaft L in the rotational direction.

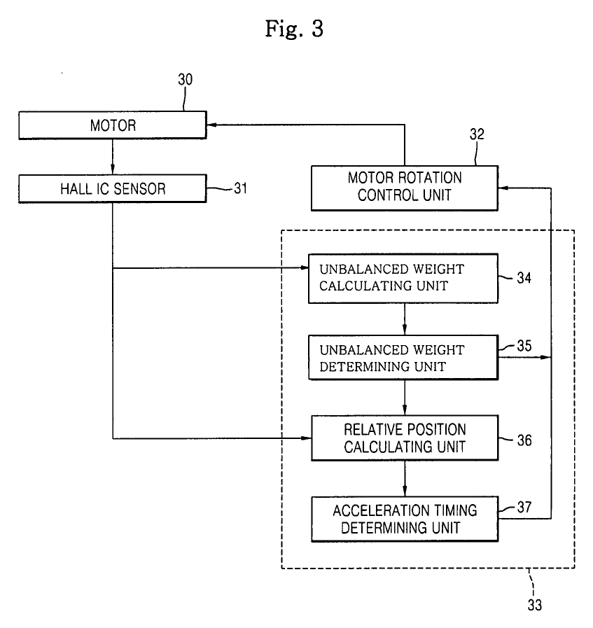

The motor 30 includes a Hall IC sensor 31 measuring the rotation speed ω of the motor 30. The operation of the motor 30 is controlled by a motor rotation control unit 32 (FIG. 3).

The pair of balancing devices 40 is provided to the front panel 22 and the back panel 23 of the spin basket 20. The balancing device 40 includes annular races 41 which are coaxially formed with the rotation shaft L of the spin basket 20 and a plurality of balls 42 which are seated in the races 41 together with oil. The plurality of balls 42 can slide in the races 41.

Next, the operation of the balancing device 40 will be described.

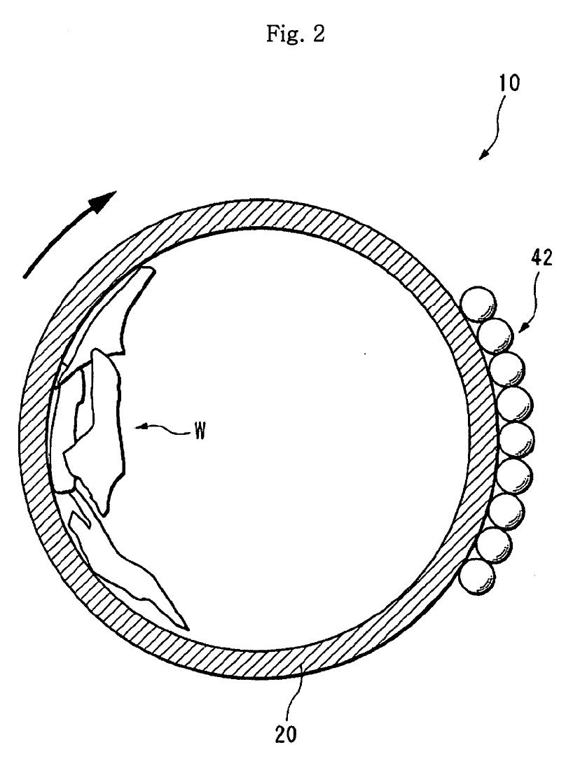

First, laundry W is put into the spin basket 20 and the spin basket 20 rotates, as shown in FIG. 2, the laundry W is attached to the inner circumferential surface of the spin basket 20. Accordingly, imbalance occurs in the spin basket 20. When the spin basket 20 rotates with the number N of rotation being larger than the inherent number v of vibrations, the plurality of balls 42 automatically moves in the balancing device 40 to remove the unbalance.

Meanwhile, when the number N of rotations of the spin basket 20 is smaller than the inherent number v of vibrations, the moving speed of the balls 42 becomes smaller than that of the imbalance (the rotation speed of the spin basket) due to the force of gravity and thus the relative position between the imbalance and the balls 42 in the circumferential direction periodically varies. Due to such variation, a bit signal B occurs. As shown in FIG. 3, the variation in rotation speed ω of the motor 30 is detected as the bit signal B using the Hall IC sensor 31 as a detecting unit.

The Hall-IC sensor 31 (detecting unit) measures the rotation speed ω of the motor 30 to detect the bit signal B. An analysis unit 33 analyzes the variation in amplitude Δω of the bit signal B (the rotation speed ω of the motor 30) and the motor rotation control unit 32 controls the rotation of the motor 30 (the rotation of the spin basket). More particularly, an unbalanced weight calculating unit 34 calculates an unbalanced weight from the bit signal B and an unbalanced weight determining unit 35 determines a relationship between the unbalanced weight and the ball weight. In addition, a relative position calculating unit 36 calculates the relative position between the ball 42 and the imbalance from the bit signal B and an acceleration timing determining unit 37 determines the acceleration timing of the spin basket 20. The motor rotation control unit 32 controls the rotation of the spin basket 20 by the determined results of the unbalanced weight determining unit 35 and the acceleration timing determining unit 37.

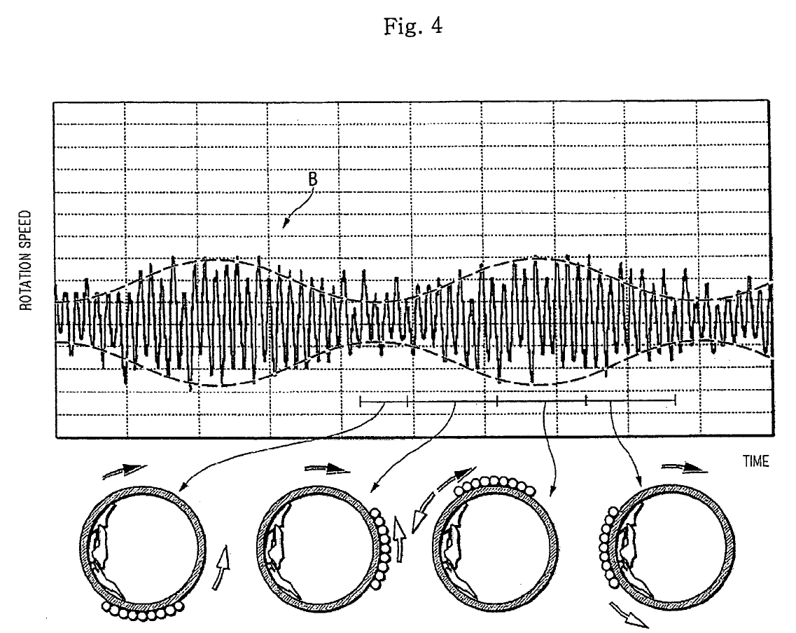

The relationship between the bit signal B and the relative position between the imbalance and the balls 42 in the circumferential direction is shown in FIG. 4. When the imbalance and the balls 42 are positioned at the opposite phase in the circumferential direction, the vibrations are suppressed and thus the amplitude of the bit signal B (the amplitude Δω of the rotation speed ω of the motor 30) is minimized. Meanwhile, when the imbalance and the balls 42 are positioned at the same phase in the circumferential direction, a large force is applied to the rotation shaft L and the vibrations increase. Thus, the amplitude of the bit signal B (the amplitude Δω of the rotation speed Co of the motor 30) is maximized.

When the amplitude of the bit signal B gradually increases, the imbalance and the balls 42 move relative to each other from the same phase to the opposite phase. When the amplitude of the bit signal B gradually decreases, the imbalance and the balls 42 move relative to each other from the opposite phase to the same phase.

Subsequently, a method of calculating the unbalanced weight from the bit signal will be described.

The rotation speed ω of the motor 30 is expressed by Equation 1.

In Equation 1, M_{unb} is the unbalanced weight, M_{ball} is the total weight of the balls 42, ωₛ is the rotation speed of the spin basket 20, ω_{b} is the rotation speed of the balls 42, α and β are initial phases, J is the total amount of inertia, r is the radius of rotation, g is the acceleration of gravity, and τ is the torque of the motor 30.

$$J \cdot \frac{ⅆ ω}{ⅆ t} = τ + {M}_{unb} \cdot gr \cdot sin ( {ω}_{s} t + α ) + {M}_{ball} \cdot gr \cdot sin ( {α}_{s} t + β ) \qquad Equation 1$$

The amplitude Δω of the rotation speed ω of the motor 30 becomes a maximum when the imbalance and the balls 42 are positioned at the same phase and minimizes when the imbalance and the balls 42 are positioned at the opposite phase. Accordingly, when Equation 1 is specified by the maximum and the minimum, Equations 2 and 3 are obtained.
Δωₘₐₓ=k₂×(M_{unb}+M_{ball}), in the case of the same phase Equation 2
Δωₘᵢₙ=k₂×|M_{unb}−M_{ball}|, in the case of the opposite phase Equation 3

From Equations 2 and 3, the unbalanced weight M_{unb} is expressed by Equations 4 and 5. Here, k₁=½k₂, wherein k₂ represents unbalanced speed generated per unit mass.
M_{unb}=k₁×(Δωₘₐₓ+Δωₘᵢₙ), in the case of M_{unb}>M_{ball} Equation 4
M_{unb}=k₁×((Δωₘₐₓ−Δωₘᵢₙ), in the case of M_{unb}<M_{ball} Equation 5

By Equations 4 and 5, the unbalanced weight is calculated from the measurement value of the rotation speed ω of the motor 30.

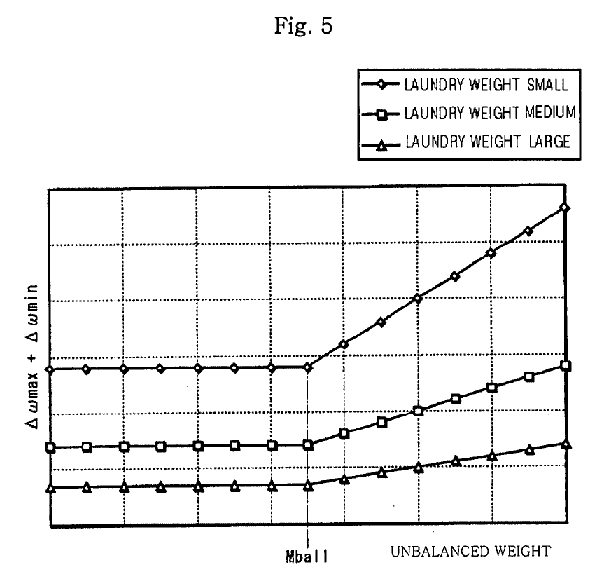

In order to determine whether the unbalanced weight is larger than the total weight of the balls 42, only Equation 4 is considered. In the measurement of (Δωₘₐₓ+Δωₘᵢₙ)=A, as shown in FIG. 5, when the unbalanced weight is smaller than the total weight M_{ball} of the balls 42, (Δωₘₐₓ+Δωₘᵢₙ)=A is uniform, and, when the unbalanced weight exceeds the total weight M_{ball} of the balls 42, (Δωₘₐₓ+Δωₘᵢₙ)=A begins to increase. Since the value of (Δωₘₐₓ+Δωₘᵢₙ)=A varies due to the weight of the laundry W in the spin basket 20 as shown in FIG. 5, the weight of the laundry W in the spin basket 20 is measured by a known laundry amount detecting device and a threshold value ξ of (Δωₘₐₓ+Δωₘᵢₙ)=A is previously selected.

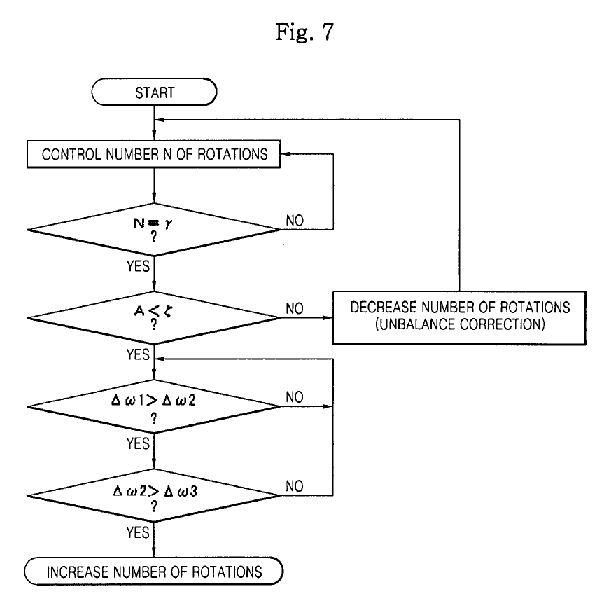

The Hall IC sensor 31 measures the rotation speed ω of the motor 30, the unbalanced weight calculating unit 34 calculates the unbalanced weight as described above, and the unbalanced weight determining unit 35 compares the unbalanced weight with the total weight of the balls 42. When the unbalanced weight is larger than the total weight of the balls 42, as shown in FIG. 7, the number N of rotations of the spin basket 20 decreases to detach the laundry W from the inner circumferential surface of the spin basket 20, thereby correcting the imbalance.

Subsequently, a method of calculating the relative position between the imbalance and the balls 42 using the bit signal B and controlling the rotation of the spin basket 20 will be described.

As shown in FIG. 4, the amplitude Δω of the rotation speed ω of the motor 30 are calculated in a predetermined period and the relative position between the imbalance and the balls 42 is calculated by the variation in amplitude Δω.

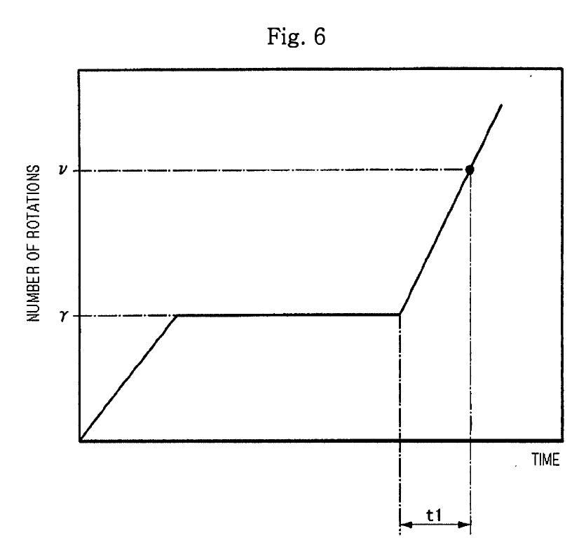

In the initial period of the dehydrating process, since the laundry contains a large amount of water and the discharge of water is insufficient, the number N of rotations of the spin basket 20 does not need to rapidly increase. Accordingly, in the initial period of the dehydrating process, as shown in FIG. 6, the number N of rotations is maintained at γ in a predetermined period and then increases with a predetermined rising rate (acceleration).

Accordingly, an acceleration time period t1 from an acceleration start time point to a time point reaching the inherent number v of vibrations of the spin basket 20 is calculated by the initial number N of rotations of γ and the rising rate (acceleration). The acceleration timing determining unit 37 calculates the variation in phase in the acceleration time period t1 and determines the acceleration timing such that the balls 42 and the imbalance are positioned at the opposite phase when the number N of rotations of the spin basket 20 reaches the inherent number v of vibrations.

As shown in FIG. 7, the amplitude of the bit signal B is sequentially measured with time, the measured values Δω1, Δω2 and Δω3 are compared, and the number N of rotations of the spin basket 20 increases such that the Δω1>Δω2 and Δω2>Δω3 are accomplished, that is, the amplitude Δω decreases.

Since the washing machine 10 includes the Hall IC sensor 31 detecting the rotation speed ω of the motor 30 as the bit signal B, the unbalanced weight calculating unit 34 analyzing the bit signal B and calculating the unbalanced weight, and the unbalanced weight determining unit 35 comparing the unbalanced weight with the total weight of the balls 42, and the motor rotation control unit 32 controls the number N of rotations of the spin basket 20 to be temporarily reduced when the unbalanced weight exceeds the total weight of the balls 42 to perform the imbalance correction, it is possible to reliably suppress the vibrations of the spin basket 20 due to the balancing device 40. Accordingly, it is possible to reliably prevent the generation of the natural vibrations in the dehydrating process.

In addition, since the washing machine 10 includes the relative position calculating unit 36 analyzing the bit signal B and calculating the relative position between the balls 42 and the imbalance and the acceleration timing determining unit 37 determining the acceleration timing of the spin basket 20, it is possible to determine the acceleration timing such that the balls 42 and the imbalance are positioned at the opposite phase at the time point when the number N of rotations of the spin basket 20 reaches the inherent number v of vibrations and to prevent the significant resonance of the spin basket 20 to suppress the generation of the abnormal vibrations.

In the embodiment of the present invention, since the Hall IC sensor 31 included in the motor 30 is used as the detecting unit detecting the bit signal B, it is possible to detect the bit signal B without separately providing a special sensor and to suppress the vibrations without increasing the manufacturing cost of the washing machine 10.

Although the washing machine 10 is described as an embodiment of the present invention, the present invention is not limited to this embodiment and may be adequately changed without departing from the scope of the present invention.

An apparatus including the rotating body control device is not limited to the washing machine 10 and is applicable to industrial equipment or products, such as a centrifugal separator.

Although the Hall IC sensor 31 detects the variation in period of the rotation speed ω of the motor 30 as the bit signal B, the present invention is not limited thereto. The variation in current value of the motor 30 may be detected as the bit signal B by uniformly controlling the rotation speed ω of the motor 30 or the variation in period of the acceleration of the motor 30 may be detected by an acceleration sensor as the bit signal B.

As described above, according to the rotating body control device and the washing machine including the same of the embodiment of the present invention, it is possible to reliably suppress the vibrations due to the balancing unit and to reliably suppress the generation of the abnormal vibrations due to the relative position between the imbalance, which occurs in the rotating body, and the rolling bodies of the balancing unit.

Although an embodiment has been shown and described, it would be appreciated by those skilled in the art that changes may be made in this embodiment without departing from the principles and spirit of the invention, the scope of which is defined in the claims and their equivalents.

What is claimed is:

1. A rotating body control device controlling rotation of a rotating body including a rotation shaft, the device comprising:
a balancing unit including an annular race which is integrally formed with the rotating body and is concentric with the rotation shaft of the rotating body and a plurality of rolling bodies which are movably seated in the race;
a detecting unit detecting a bit signal, which is generated according to a variation in relative position between the rolling bodies seated in the race and an eccentric amount of the rotating body during the rotation of the rotation body;
an analyzing unit which analyzes a variation in amplitude of the bit signal detected by the detecting unit; and
a control unit which controls the rotation of the rotating body according to the analyzed variation in amplitude.

2. The device according to claim 1, wherein:
the analyzing unit calculates an unbalanced weight, which occurs in the rotating body, due to the variation in amplitude of the bit signal detected by the detecting unit and compares the unbalanced weight with a total weight of the rolling bodies, and
the control unit controls a number of rotations of the rotating body to be temporarily reduced at a time when the unbalanced weight exceeds the total weight of the rolling bodies.

3. The device according to claim 1, wherein the analyzing unit calculates a relative position between the rotating body in an eccentric state and the rolling bodies by the variation in amplitude of the bit signal detected by the detecting unit and controls an acceleration timing of the rotating body such that the rotating body and the rolling bodies are positioned at opposite phases at a time when the number of rotations of the rotating body is equal to an inherent number of vibrations of the rotating body.

4. The device according to claim 2, wherein the analyzing unit calculates a relative position between the rotating body in an eccentric state and the rolling bodies by the variation in amplitude of the bit signal detected by the detecting unit and controls an acceleration timing of the rotating body such that the rotating body and the rolling bodies are positioned at opposite phases at a time when the number of rotations of the rotating body is equal to an inherent number of vibrations of the rotating body.

5. A washing machine comprising the device according to claim 1, wherein the rotating body is a spin basket which has an inner space seating laundry therein and is rotatably mounted about the rotation shaft.

6. The washing machine according to claim 5, wherein:
the analyzing unit calculates an unbalanced weight, which occurs in the spin basket, due to the variation in amplitude of the bit signal detected by the detecting unit and compares the unbalanced weight with a total weight of the rolling bodies,
the control unit controls a number of rotations of the spin basket to be temporarily reduced at a time when the unbalanced weight exceeds the total weight of the rolling bodies.

7. The washing machine according to claim 5, wherein the analyzing unit calculates a relative position between the spin basket in an eccentric state and the rolling bodies by the variation in amplitude of the bit signal detected by the detecting unit and controls an acceleration timing of the spin basket such that the spin basket and the rolling bodies are position at opposite phases at a time when the number of rotations of the spin basket is equal to an inherent number of vibrations of the spin basket.

8. The washing machine according to claim 6, wherein the analyzing unit calculates a relative position between the spin basket in an eccentric state and the rolling bodies by the variation in amplitude of the bit signal detected by the detecting unit and controls an acceleration timing of the spin basket such that the spin basket and the rolling bodies are position at opposite phases at a time when the number of rotations of the spin basket is equal to an inherent number of vibrations of the spin basket.

9. A rotating body control device controlling rotation of a rotating body, the device comprising:
a race surrounding the rotating body;
a plurality of rolling bodies in the race, such that a speed of the rotating body varies according to a position of the rolling bodies;
a detector to detect a speed of the rotating body; and
a controller to vary the speed of the rotating body according to the detected speed.

10. The device according to claim 9, wherein the speed of the rotating body is decreased when the detected speed is above a threshold.

11. The device according to claim 9, wherein the speed of the rotating body varies according to a phase difference between the rolling bodies and the rotating body.
